(19) United States
(12) Patent Application Publication
(10) Pub. No.: US 2013/0050132 A1
(43) Pub. Date: Feb. 28, 2013

(54) TECHNIQUES FOR CAPACITIVE TOUCH SCREEN CONTROL

(71) Applicants: Javier Calpe Maravilla, Alegemesi (ES); Alberto Marinas, El Puig (ES); Santiago Iriarte, Valencia (ES); Enrique Company Bosch, Alginet (ES); Miguel Chanca, Valencia (ES); Reza Alavi, Belle Mead, NJ (US); Vladimir Friedman, Scotch Plains, NJ (US); John Cleary, Kilmallock (IE)

(72) Inventors: Javier Calpe Maravilla, Alegemesi (ES); Alberto Marinas, El Puig (ES); Santiago Iriarte, Valencia (ES); Enrique Company Bosch, Alginet (ES); Miguel Chanca, Valencia (ES); Reza Alavi, Belle Mead, NJ (US); Vladimir Friedman, Scotch Plains, NJ (US); John Cleary, Kilmallock (IE)

(73) Assignee: ANALOG DEVICES, INC., Norwood, MA (US)

(21) Appl. No.: 13/218,788

(22) Filed: Aug. 26, 2011

(51) Int. Cl. G06F 3/045

(52) U.S. Cl. 345/174

(57) ABSTRACT

Techniques to control a capacitive touch screen that decrease processing time and increase noise rejection. The techniques may include injecting a plurality of excitation signals having unique spectral profiles onto conductors of the capacitive touch screen, sampling signals returned from the screen, and determining a location of touch. The techniques may further include injecting a plurality of excitation signals having unique spectral profiles onto adjacent or non-adjacent conductors of the capacitive touch screen. The techniques may further include injecting a plurality of excitation signals having unique spectral profiles onto conductors of the capacitive touch screen in unequal measures. The techniques may also include mapping frequency characteristics of noise present on the capacitive touch screen.

### BACKGROUND

A capacitive touch screen is an electronic device that registers touch operations performed on the screen. Generally, the structure of a capacitive touch screen is well-known. FIG. 1 illustrates a typical capacitive touch screen 100.

FIG. 1 illustrates a typical capacitive touch screen 100. The screen includes a transparent window layer 110, a transparent touch panel layer 120 having interleaved rows 122.1-122.n and columns 124.1-124.m with conductive properties that are separated by a dielectric material. The screen may further include a semi-transparent polarizing layer 130, and an LCD or similar display panel 140 (OLED, AMOLED, etc.) that displays image content viewable through the polarizing layer 130, the touch panel layer 120, and the window layer 110.

Operation of the capacitive touch screen is managed by a control system. The control system sequentially injects an electric input signal to sequentially excite conductive nodes of the touch panel layer 120. The excited nodes create an electrostatic field above the surface of the touch panel layer 120. As a user approximates a finger near or touches a point or multiple points on the transparent window layer 110, the electrostatic field changes for the touch panel layer 120. The system measures field changes along the conductive nodes of the touch panel layer 120. The system processes the measurements to determine touch locations or touch gestures.

Capacitive touch screens are used in a variety of applications including automotive, aviation, marine, and consumer electronic applications. For each application, unpredictable electromagnetic noise or interference is induced on capacitive touch screens. Such noise originates from a variety of sources including switching power supplies, refresh cycles of LCD display panels, and operating environments. Increased noise or interference increases the time, energy, and/or complexity required by a system to sequentially inject input signals, measure electrostatic field changes, and determine touch locations or touch gestures. As technology has advanced, screen size has also increased even further increasing the scanning time for control systems that sequentially inject and process signals. Moreover, new technologies such as in-cell caps increase the demands.

Accordingly, there is a need in the art for techniques to provide for capacitive touch screen control that decrease processing time and increase noise rejection.

### BRIEF DESCRIPTION OF THE DRAWINGS

FIG. 1 illustrates a typical capacitive touch screen.

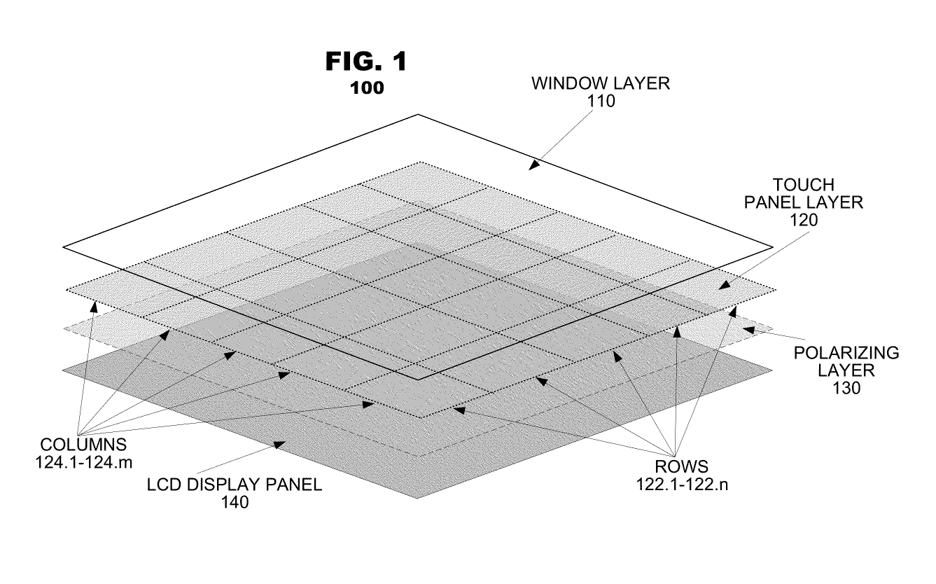

FIG. 2 illustrates a control system for a capacitive touch screen according to an embodiment of the present invention.

FIG. 3 illustrates a method for detecting touch operations performed on a capacitive touch screen according to an embodiment of the present invention.

FIG. 4 illustrates a method for mapping noise for a capacitive touch screen according to an embodiment of the present invention.

FIG. 5 illustrates a method for control of a capacitive touch screen according to an embodiment of the present invention.

FIG. 6 illustrates a simplified block diagram of a system for processing signals output from a capacitive touch screen according to an embodiment of the present invention.

### DETAILED DESCRIPTION

Embodiments of the present invention provide techniques to control a capacitive touch screen that decrease processing time and increase noise rejection. The techniques may include injecting a plurality of excitation signals having unique spectral profiles onto conductors of the capacitive touch screen, sampling signals returned from the screen, and determining a location of touch. The techniques may further include injecting a plurality of excitation signals having unique spectral profiles onto adjacent or non-adjacent conductors of the capacitive touch screen. The techniques may further include injecting a plurality of excitation signals having unique spectral profiles onto conductors of the capacitive touch screen in unequal measures. The techniques may also include mapping frequency characteristics of noise present on the capacitive touch screen.

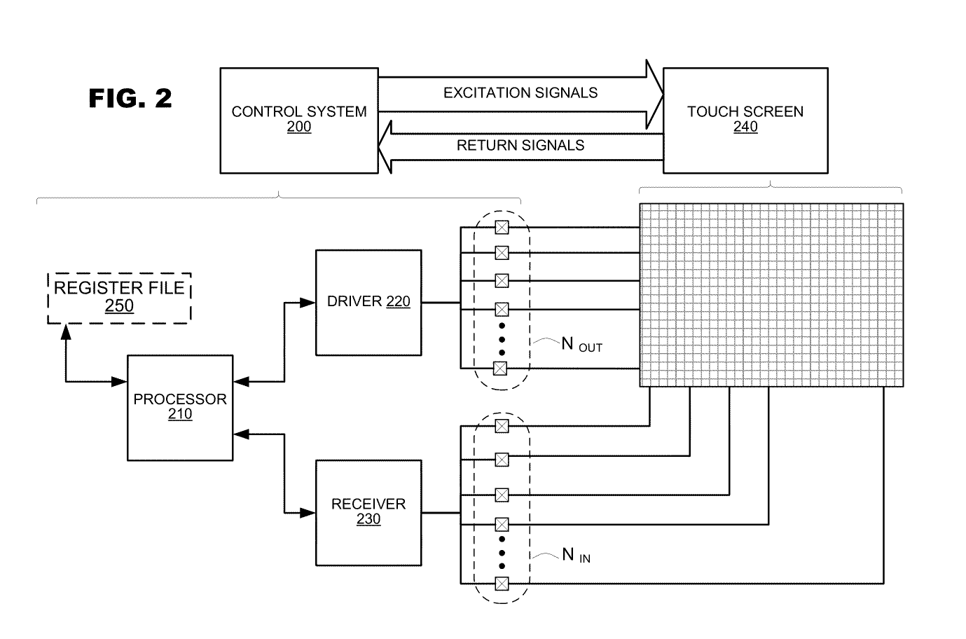

FIG. 2 illustrates a control system 200 for a capacitive touch screen according to an embodiment of the present invention. The system 200 may generate a plurality of excitation signals simultaneously, which may be applied to a first set of conductors of the touch screen 240. The system 200 may receive a plurality of return signals from second conductors of the touch screen 240, which are generated by capacitive coupling between the first and second conductors. The return signals also may include components affected by environmental or system noise sources. Typically the system 200 may generate frequencies in the range from 5 kHz to 250 kHz but the use of lower frequency excitation signals (<50 kHz) may be preferred to limit attenuation by the screen.

The system 200 may include a processor 210, a signal driver 220, and a receiver 230. The processor 210 may manage operation of the system. The signal driver 220 may drive multiple signals having unique spectral characteristics to output nodes N_{OUT}, which may be coupled to the first conductors of the capacitive touch screen 240. The receiver 230 may receive return signals from the second conductors of the capacitive touch screen 240. The processor 210 may decode the return signals. The system 200 may be incorporated into an integrated circuit (IC). For convenience, the first set of conductors are labeled “row” conductors and the second set of conductors are labeled “column” conductors.

The system 200 may allow for high scanning rates by having the signal driver 220 drive multiple conductors of the touch screen with excitation signals having unique spectral profiles. The signals may return to the system 200 and may be sampled by the receiver 230 and interpreted by the processor 210. When touches may occur on the screen 240, the signal profiles may change as they pass through the touch screen 240. The processor 210 may resolve location(s) of the touches based on a frequency analysis of the received signal profiles. Touches may include single or multiple point touches or touch gestures performed on the capacitive touch screen 240.

In one example, the signal driver may drive four different excitation signals with unique spectral profiles having frequencies f₁-f₄. In a touch screen having 256 conductive nodes, the signal driver may generate 64 different sets of excitation signals to drive all 256 conductive nodes. As compared to other systems that generate excitation signals one at a time, this may represent a four-fold increase in performance. The system may determine both optimal frequencies and an optimal number of excitation signals for a touch screen based on detection of noise or interference that may be present on the touch screen.

The system 200 may detect touches that may be performed on the touch screen 240. In the detection mode, the system 200 may inject signals to excite first conductors of the touch screen 240 and sample return signals from the touch screen 240. The return signals may be sampled by the receiver 230. The sampled signals may be output to the processor 210 and the processor may determine if a touch operation has occurred. Typically, when a user touch occurs on the screen, it alters the capacitive coupling that occurs between the first and second conductors. If a touch operation occurs, the receiver 230 and processor 210 may interpret the return signals to derive locations of the touch operation by sensing changes in the capacitive coupling.

In a first embodiment, the system 200 may inject a predetermined number N of excitation signals onto N adjacent conductors of the touch screen 240. For example, in a system having N=4 unique excitation signals and where the excitation signals are applied to rows of the touch screen, the system may inject the excitation signals iteratively onto rows 1-4, rows 5-8, rows 9-12, etc. of the touch screen 240 until excitation signals have been driven onto all rows. In each iteration, the receiver 230 may sample returns signals to derive a location of touch. The system may return to rows 1-4 after driving the last row in the touch screen. This manner of operation may be performed for any number of excitation signals that may be desired (N=6, 8, 12).

In another embodiment, the system may inject the N number of excitation signals onto non-adjacent conductors of the touch screen. Continuing with the example where N=4, unique excitation signals may be applied to rows 1, 13, 25 and 37 in a first iteration. The excitation signals may be applied to rows 2, 14, 26 and 38 in a second iteration. The excitation signals may advance throughout the touch screen with equal spacing between conductors until all rows have been driven. In each iteration, the receiver 230 may sample returns signals to derive a location of touch. The system may return to the first set of rows (nos. 1, 13, 25 and 37 in this example) after all rows of the touch screen have been driven.

In another embodiment, the system may inject excitation signals onto touch screen conductors in unequal measures. If the system has detected a touch at a first location on the touch screen, the system may increase the rate at which excitation signals are driven to the region at which the touch was detected. Touches are resolved at coordinates corresponding to row(s) at which excitation signals are delivered when return signals are detected corresponding to column(s) of the touch. In many applications, spacing of the first and second conductors are much finer than the size of the touch event (for example, a human finger) and, therefore, the touch is detected across several rows and columns rather than a single row and a single column. When a touch is detected at a given row, a rate of excitation signals may be increased in a region surrounding the row even if the rate of excitation signal to other rows of the touch screen may decrease.

Dynamic adjustment of the rate of excitation signals may occur in other use cases. For example, the processor 210 may change the rate in association with display events that may occur on a display used in conjunction with the touch screen. For example, a user interface may display various user controls such as buttons, sliders and the like. When such user interface elements are displayed, the processor 210 may increase rates of excitation signal corresponding to the regions occupied by those elements. Further, user interfaces may display dynamically-selectable information content in active regions of a display (such as maps) which may be associated with pinch-activated view controls. Again, when such active regions are displayed, the system may increase the rate of excitation signals applied to the active regions possibly at the expense of excitation signals that are applied to other regions. Further, the system may avoid exciting areas where no touch may be expected, thus, saving power and/or increasing the scan rate in areas where touch may be expected.

A variety of different types of excitation signals may find application with different embodiments of the present invention. The unique spectral profiles for excitation signals may be chosen so as to have unique frequency components when they are combined into return signals due to capacitive coupling of the touch screen. In one embodiment, the excitation signals may be sinusoidal signals having discriminating frequencies. Components of each excitation signal may be identified within the return signals by Fourier transforms or narrow band filters. The excitation signals each may be multi-frequency signals, which again may be identified within the return signals by Fourier transforms or narrow band filters. In other embodiments, the excitation signals may be provided as square waves or triangular waveforms each having unique frequency signatures so as to be discernable in the return signals. In another embodiment, the excitation signals may be pseudo-random signals that have low correlation to the other excitation signals. In another embodiment, the excitation signals may be stationary (having constant amplitude, phase, frequency, etc.) during excitation of the touch screen. In yet another embodiment, the excitation signals may be non-stationary (having varying amplitude, phase, or frequency, etc.) during excitation of the touch screen.

Frequency spacing among the excitation signals may be selected dynamically in another embodiment of the present invention. As discussed below in connection with the mapping mode, the system 200 may develop a “noise map” representing frequencies in which signal corruption may be identified in the return signals in the absence of any excitation signals. In such an embodiment, the processor may select frequencies to be used for the excitation signals that avoid frequencies in which noise may be present. The frequency selection may be altered dynamically during use of the system to avoid noise effects that vary in frequency.

In an embodiment, the processor 210 may initialize a scan rate, scan order, or scan grouping for the receiver 230 to sample signals output from the touch screen 240. In an embodiment, the processor may receive control signals from an external processor (not shown). The control signals may include indicators of touch screen size or other operating information. In an embodiment, the processor 210 may transmit data/control signals to the external processor.

The system 200 also may operate in a “mapping mode” to map frequency characteristics of noise or interference present on the touch screen. During the mapping mode, the processor 210 may initialize the receiver 230 to sample signals output from the touch screen 240. The processor 210 may set a scan rate for the receiver 230 wherein the unit may sample signals on the return in the absence of any excitation signals being applied to the touch screen. After the receiver 230 may sample the output signals, the processor 210 may perform a frequency analysis on the sampled return signals to identify frequency characteristics of the return signal. The processor 210 may build a “noise map” for the capacitive touch screen 240 representing frequency bands in which sufficiently high levels of noise energy were detected. As discussed above, the noise map may be used to select frequencies to be used for excitation signals.

In an embodiment, the system 200 may be configured to repeat operation of the mapping mode at a predetermined rate (for example once every second). The system 200 may update the noise map for the touch screen 240 after each refresh time and re-select frequencies to be used for excitation signals. In another embodiment, the system 200 may be configured to update the noise map for the touch screen 240 in response to a touch being detected on the touch screen 240. Alternatively, the process may refresh the noise map in response to triggering events identified by a external processor, such as engagement of a backlight or changing brightness levels of an LCD display, having a power charger connected to the device, engagement of a wireless communication device or changing power levels of the device (e.g., waking up or sleeping a tablet computer in which the touch screen is provided).

In one embodiment, the processor 210 may store current or historical noise maps in a register file 250. In yet another embodiment, the processor 210 may output current or historical noise maps for external processing.

In an embodiment, the processor 210 may analyze a noise map (built during a mapping mode) to determine frequency allocations for the excitation signals. For example, a noise map may indicate that a touch screen may have noise frequencies occurring between 45 kHz and 55 kHz. Thus, the processor 210 may determine that the excitation signals may have frequencies between 5 kHz and 40 kHz (excluding the 45 kHz-55 kHz range). After determining a range of input frequencies, the processor 210 may initialize the signal driver 220 to inject signals into the touch screen within the 5 kHz-40 kHz range.

In an embodiment, the signal driver 220 may include a plurality of excitation signal generators, each to generate an excitation having a unique spectral profile, and multiplexers for routing the excitation signals. In an embodiment, outputs from the signal driver 220 may be coupled to pins of the IC. In an embodiment, the receiver 230 may include analog-to-digital converters (“ADCs”) and filters for sampling/conditioning signals received from the capacitive touch screen 240. In an embodiment the receiver 230 may have inputs coupled to pins of the IC.

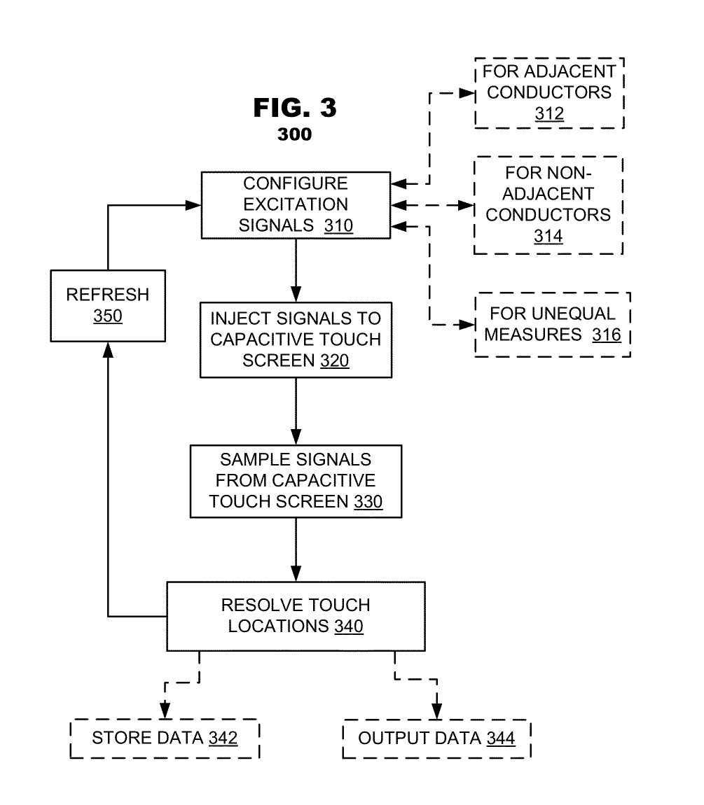

FIG. 3 illustrates a method 300 for detecting touch operations performed on a capacitive touch screen according to an embodiment of the present invention. As illustrated in FIG. 3, the method 300 may configure a predetermined number of excitation signals having unique spectral profiles to inject to respective first conductors of a capacitive touch screen (block 310). The method 300 may inject the signals into the respective first conductors (block 320). The method 300 may sample return signals from the capacitive touch screen (block 330). The method may resolve locations of touches based on frequency analysis of the received signals (block 340). The method may refresh the detection for the capacitive touch screen for a predetermined period of time (block 350).

In an embodiment, the method 300 may configure excitation signals to inject to adjacent first conductors of the capacitive touch screen (block 312). In an embodiment, the method may configure excitation signals to inject to non-adjacent first conductors of the capacitive touch screen (block 314). In an embodiment, the method may configure excitation signals to inject to first conductors of the capacitive touch screen in unequal measures (block 316). In an embodiment, the method 300 may store data representing touch locations (block 342). In an embodiment, the method may output data representing touch locations (block 344).

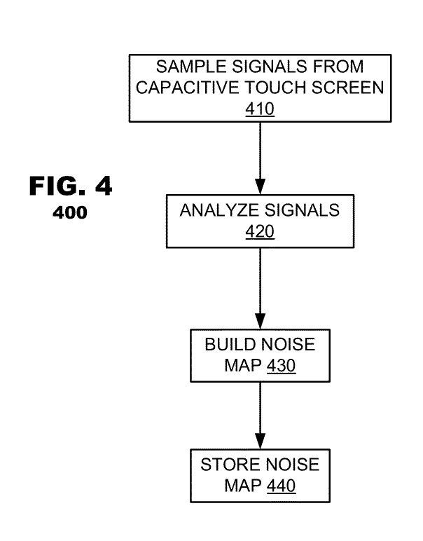

FIG. 4 illustrates a method 400 for mapping noise for a capacitive touch screen according to an embodiment of the present invention. The method 400 may sample signals from conductors of a capacitive touch screen (block 410). The method 400 may analyze the frequency spectrum of the sampled signals (block 420). The method may build a noise map identifying noisy frequency bands (block 430). The method may store the noise map for further processing (block 440).

For example, in one embodiment, the system 200 may perform a frequency transform of return signals for each frequency that the driver 220 is capable of generating and compare a level of energy in each such frequency to an energy threshold. If the energy level of a given frequency exceeds the threshold, the method may mark the frequency in a frequency bin within the noise map. Later, the system may refer to the noise map and prioritize excitation signal frequencies that are not marked in the noise map frequency bins as having high energy levels for driving into the touch screen 240.

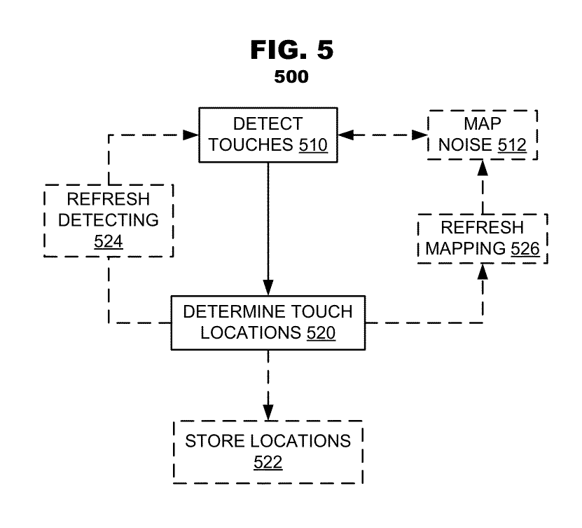

FIG. 5 illustrates a method 500 for control of a capacitive touch screen according to an embodiment of the present invention. The method may detect for touches performed on the touch screen (block 510). For detected touches, the method 500 may determine touch locations (block 520).

In an embodiment, the method 500 may map noise that may be present on a capacitive touch screen to configure excitation signals used for detection (block 512). In an embodiment, the method may store data pertaining to touches (block 522). In an embodiment, the method 500 may return to detect for touches after determining touch locations (block 524). In another embodiment, the method 500 may return to mapping noise that may be present on the capacitive touch screen after determining touch locations (block 526).

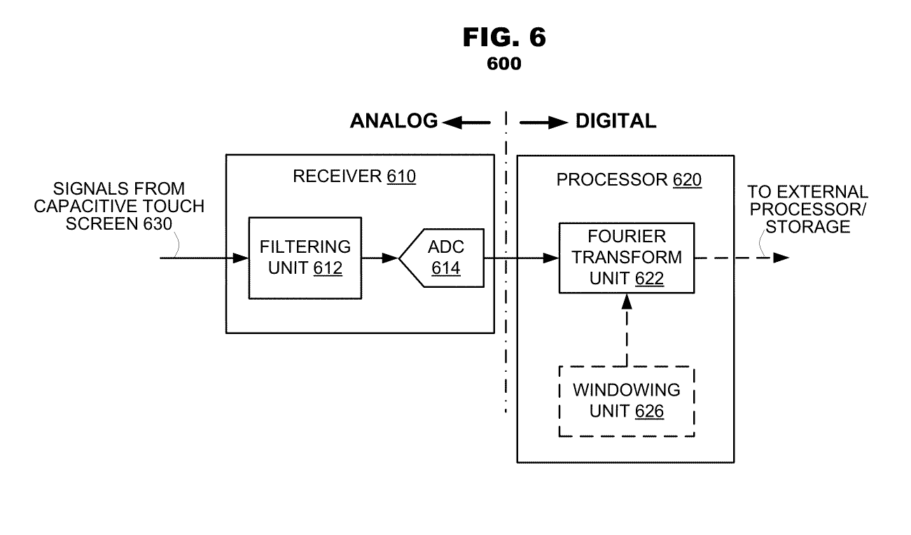

FIG. 6 illustrates a simplified block diagram of a system 600 for processing signals output from a capacitive touch screen according to an embodiment of the present invention. As illustrated in FIG. 6, a simplified system 600 for processing signals 630 from a capacitive touch screen (not shown) may include a receiver 610 having a filtering unit 612 that may receive signals from the capacitive touch screen and an analog-to-digital-converter (ADC) 614 coupled to the output of the filtering unit 612. The system 600 may further include a processor 620 having a Fourier transform unit 622 coupled to the output of the ADC 614.

During operation, the system 600 may calculate the frequency response of signals 630 from the capacitive touch screen. The signals may flow into the receiver 610 wherein the filtering unit 612 may apply a filtering calculation on the signals 630. Next the filtering unit may output filtered signals to the ADC 614. The ADC may convert the signals from the analog to digital domain using a predetermined sampling rate. The ADC 614 may output the sampled signals to the processor 620. Within the processor 620, the sampled signals may flow into the Fourier transform unit 622. The Fourier transform unit 622 may apply a predetermined Fourier transform calculation on the signals. The Fourier transform calculation may convert the sampled signals to the frequency domain. The Fourier transform unit 622 may output frequency domain signals for further processing.

In an embodiment, the filtering unit 612 may apply a low pass filtering calculation on the signals 630. In another embodiment, the filtering unit may apply a bandpass filtering calculation on the signals 630. In different embodiments, the Fourier transform unit may apply different types of Fourier transforms. These may include any Fourier transform calculation, including, but not limited to, discrete Fourier transform, fast Fourier transform, Goertzel, and CORDIC calculations. In another embodiment, narrow band filtering may be performed on the sampled signals.

In an embodiment, the system 600 may include a windowing unit 626. The windowing unit 626 may apply a windowing calculation to the time domain sampled signals from the ADC 614 or the frequency domain signals generated by the Fourier transform calculation. The windowing calculation may reduce the effects of noise that may occur outside a predetermined frequency for the sampled signals. Thus, the windowing calculation may decrease the effect of spectral leakage of the frequency domain signals. In different embodiments, various window types may be used including Blackman, Hamming, Hann, Rectangular, Blackman-Harris, Chebyshev, or Bessel, among others. In one embodiment, the windowing unit 626 may be hard-coded with a known windowing calculation type. In another embodiment, the processor 620 may set a predetermined windowing calculation type for the windowing unit 626.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A control system for a capacitive touch screen, comprising:
a signal driver, comprising a plurality of simultaneously active excitation signal generators, each to generate an excitation signal having a unique spectral profile, the signal driver having outputs for connection to the capacitive touch screen; and
a receiver system having inputs for receiving return signals from the capacitive touch screen and having a plurality of decoders to decode the return signals according to the profiles of the return signals.

2. The system of claim 1, wherein the excitation signals having unique spectral profiles are stationary.

3. The system of claim 1, wherein the excitation signals having unique spectral profiles are non-stationary.

4. The system of claim 1, wherein the signal driver drives excitation signals having unique spectral profiles in parallel to the capacitive touch screen.

5. The system of claim 1, wherein the signal driver drives excitation signals having unique spectral profiles in parallel groups to the capacitive touch screen.

6. The system of claim 1, wherein the receiver system applies a predetermined filtering calculation to the return signals received from the capacitive touch screen.

7. The system of claim 1, the receiver system further comprising at least one analog-to-digital converter.

8. The system of claim 1, the receiver system further comprising a processor.

9. The system of claim 8, wherein the processor applies a Fourier transform calculation on the return signals.

10. The system of claim 9, wherein the processor applies a windowing calculation on the return signals.

11. The system of claim 8, wherein the processor applies a narrow band filtering calculation on the return signals.

12. The system of claim 8, wherein the processor applies a predetermined gain to the return signals.

13. A method for detecting touch operations performed on a capacitive touch screen, comprising:
injecting a plurality of excitation signals having unique spectral profiles to respective first conductors of the capacitive touch screen;
sampling return signals from second conductors of the capacitive touch screen; and
detecting the unique signal characteristics within the return signals to determine a location of touch.

14. The method of claim 13, wherein the excitation signals having unique spectral profiles are stationary.

15. The method of claim 13, wherein the excitation signals having unique spectral profiles are non-stationary.

16. The method of claim of claim 13, the injecting further comprising:
injecting the plurality of excitation signals having unique signal profiles to respective first conductors of the capacitive touch screen at different rates.

17. The method of claim 13, the injecting signals further comprising:
injecting the plurality of excitation signals having unique spectral profiles to adjacent first conductors of the capacitive touch screen.

18. The method of claim 13, the injecting signals further comprising:
injecting the plurality of excitation signals having unique spectral profiles to non-adjacent first conductors of the capacitive touch screen.

19. The method of claim 13, the injecting signals further comprising:
injecting the plurality of excitation signals having unique spectral profiles to the first conductors of the capacitive touch screen in unequal measures.

20. The method of claim 19, wherein the plurality of excitation signals are injected to only a part of the capacitive touch screen.

21. The method of claim 19, wherein the plurality of excitation signals are injected to different parts of the capacitive touch screen at different injection rates based on active regions for the screen.

22. The method of claim 19, wherein the plurality excitation signals are injected to different parts of the capacitive touch screen based on an application context for the screen.

23. The method of claim 13, the injecting signals further comprising:
mapping noise frequencies for the capacitive touch screen; and
selecting frequencies for the excitation signals according to the noise frequencies.

24. The method of claim 13, the sampling return signals further comprising:
applying a filtering calculation to the return signals.

25. The method of claim 13, the detecting unique signal characteristics further comprising:
applying a Fourier transform calculation on the return signals.

26. The method of claim 13, the detecting unique signal characteristics further comprising:
applying a windowing calculation on the return signals.

27. The method of claim 13, the detecting unique signal characteristics further comprising:
applying a narrow band filtering calculation on the return signals.

28. The method of claim 13, the detecting unique signal characteristics further comprising:
storing the location of touch.

29. The method of claim 13, the detecting unique signal characteristics further comprising:
outputting the location of touch.

30. A method for mapping noise of a capacitive touch screen comprising:
sampling return signals from the touch screen in the absence of excitations signals being applied to the touch screen;
performing a frequency transform on the sampled return signals;
developing a noise map of the sampled return signals with reference to frequencies of candidate excitation signals that can be driven by a driver circuit to the capacitive touch screen.

31. The method of claim 30, the developing a noise map further comprising:
storing the noise map.
